(19) United States
(12) Patent Application Publication
(10) Pub. No.: US 2025/0211914 A1
(43) Pub. Date: Jun. 26, 2025

(54) ELECTRONIC DEVICE

(71) Applicant: Honor Device Co., Ltd., Shenzhen (CN)

(72) Inventors: Weijie Shi, Shenzhen (CN); Mingyu Jin, Shenzhen (CN); Youhong Cheng, Shenzhen (CN); Qifan Bai, Shenzhen (CN); Qingqing Duan, Shenzhen (CN)

(21) Appl. No.: 18/849,377

(22) PCT Filed: Aug. 24, 2023
(86) PCT No.: PCT/CN2023/114719

§ 371 Date: Sep. 20, 2024

(30) Foreign Application Priority Data
Oct. 31, 2022 (CN) 202211366386.9

(51) Int. Cl. H04R 9/06; H04R 1/28

(52) U.S. Cl. CPC H04R 9/06; H04R 1/2857; H04R 2499/11

(57) ABSTRACT

This application discloses an electronic device, including a housing, a speaker module, and a sound conduction channel. A sound outlet hole communicating an inside of the housing with the outside is provided on the housing. The speaker module is arranged in the housing. The speaker module includes a shell and a sound-emitting unit arranged in the shell. The sound-emitting unit and the shell enclose a front sound cavity. The sound conduction channel includes an input end for receiving sound waves and a diffusion end for diffusing sound waves. The input end of the sound conduction channel communicates with the front sound cavity through the through hole. The diffusion end communicates with the outside through the sound outlet hole. A cross-sectional area of the sound conduction channel increases gradually in a direction from the input end to the diffusion end.

### CROSS-REFERENCE TO RELATED APPLICATIONS

This application is a National Stage of International Application No. PCT/CN2023/114719, filed on Aug. 24, 2023, which claims priority to Chinese Patent Application No. 202211366386.9, filed on Oct. 31, 2022, both of which are hereby incorporated by reference in their entireties.

### TECHNICAL FIELD

This application relates to the field of electronic devices, and more specifically, to an electronic device having a speaker.

### BACKGROUND

When a user uses electronic devices such as a mobile phone, a notebook computer, a tablet computer, and a television, sound quality of a speaker at a medium-low frequency directly determines performance of the speaker, and has a significant impact on sound quality experience of the user. This is because most sound frequencies of musical instruments and most human voice frequencies are in a medium-low frequency band. If sensitivity of the speaker in the medium-low frequency band is higher, hearing experience of the user is better. Therefore, to improve the sound quality experience of the user using the speaker, related electronic device manufacturers focus on performance optimization of sound performance of the speaker in the medium-low frequency band.

Currently, in optimizing the sound performance of the speaker in the medium-low frequency band, the hearing experience for the medium-low frequency band is improved primarily by increasing a rear sound cavity, reducing an equivalent radiant area, increasing compliance of a corrugated rim, increasing mass of a voice coil, increasing an electromechanical coupling factor, and so on. However, these manners have a limited effect on sound quality improvement of the speaker in the medium-low frequency band, and cannot not satisfy constant pursuit of users for the sound quality experience of the speaker.

### SUMMARY

An objective of this application is to provide an electronic device. To resolve a technical problem in the related art of a limited effect on sound quality improvement of speakers in a medium-low frequency band, a sound conduction channel of a horn-like spatial structure is designed, to improve sensitivity of the speaker in the medium-low frequency band, providing a user with better hearing experience.

This application provides an electronic device, including a housing, a speaker module, and a sound conduction channel.

A sound outlet hole communicating an inside of the housing with the outside is provided on the housing.

The speaker module is arranged in the housing. The speaker module includes a shell and a sound-emitting unit arranged in the shell. The sound-emitting unit and the shell enclose a front sound cavity. A through hole communicating the front sound cavity with the inside of the housing is provided on the shell.

The sound conduction channel includes an input end for receiving sound waves and a diffusion end for diffusing sound waves. The input end of the sound conduction channel communicates with the front sound cavity through the through hole. The diffusion end communicates with the outside through the sound outlet hole. A cross-sectional area of the sound conduction channel increases gradually in a direction from the input end to the diffusion end.

In this application, a cross-sectional area of the sound conduction channel of the electronic device gradually increases in a direction from the input end to the diffusion end, so that the sound conduction channel exists in the horn-like spatial structure, to improve the sensitivity of the speaker in the medium-low frequency band, providing the user with better hearing experience. A specific reason is as follows: Since effects of forces are reciprocal, when the sound-emitting unit vibrates in the air to radiate sound waves outwards, there is necessarily a reaction force from the air to the sound-emitting unit. For a sound-source vibration system, this is equivalent to adding force impedance to an original mechanical vibration system. Such force impedance added to the mechanical system due to sound radiation is referred to as radiation force impedance, and is simply referred to as radiation impedance. Due to the radiation impedance, an energy loss is caused during operation of the speaker. The energy loss is not lost to the air in a form of thermal energy, but is converted into acoustic energy and transmitted in a form of sound waves. Moreover, greater radiation impedance indicates that more energy is transmitted in the form of sound waves in the speaker. Therefore, efficiency of electro-acoustic conversion of the speaker is higher. In this application, the sound conduction channel of the electronic device exists in the horn-like spatial structure. Compared with a conventional sound conduction duct structure, the horn-like sound conduction channel can produce higher radiation impedance for the sound-emitting unit. Therefore, driven at a same power, the speaker of the electronic device in this application has higher efficiency when performing electric-acoustic conversion, leading to an increase in a sound pressure level of the sound-emitting unit in each audio frequency band, particularly in the medium-low frequency band, in which sensitivity of the sound-emitting unit is higher. Therefore, the speaker performs better in resolving most musical instrument sounds and human voices, thereby improving hearing enjoyment of the user.

In a possible design, the electronic device further includes:
a sound conduction tube, where a tube cavity of the sound conduction tube forms the sound conduction channel.

In a possible design, the sound conduction tube includes a first tube section. An end of the first tube section is connected to the sound outlet hole of the housing, an other end of the first tube section is connected at the through hole of the shell, and the entire first tube section is arranged in a meandering manner.

In a possible design, the first tube section is bent into an L-shaped structure, a U-shaped structure, an S-shaped structure, or a spiral structure.

In a possible design, the sound conduction tube further includes a second tube section, the first tube section is connected at the through hole through the second tube section, and the second tube section is bent and arranged closely on an outer surface of the shell.

In a possible design, the sound conduction tube further includes a third tube section. The first tube section is connected at the sound outlet hole through the third tube section, and the third tube section is bent to compensate for a position offset of a tube opening of the first tube section relative to the sound outlet hole.

In a possible design, the sound conduction tube is connected to the housing by adhesive bonding or by a tube clamp bracket.

In a possible design, a cross-sectional shape of the sound conduction channel includes one of a circle, a rectangle, or an ellipse.

In a possible design, the shell includes a front shell and a rear shell. The front shell includes a first front shell portion and a second front shell portion protruding from an outer surface of the first front shell portion. The sound-emitting unit is arranged at a joint between the first front shell portion and the second front shell portion, so that the sound-emitting unit and the second front shell portion enclose the front sound cavity. The sound-emitting unit, the first front shell portion, and the rear shell enclose a rear sound cavity.

In a possible design, a root portion of the second front shell portion extends toward the rear shell to form an annular block, and the sound-emitting unit is embedded inside the annular block.

In a possible design, a bump is arranged on one of an inner side of the annular block and the sound-emitting unit, a clamping slot is provided on the other of the inner side of the annular block and the sound-emitting unit, and the bump can be clamped into the clamping slot, so that the sound-emitting unit is connected to the annular block.

In a possible design, a step around a circle is further arranged on the inner side of the annular block, and the sound-emitting unit abuts against the step.

In a possible design, the housing includes a first housing and a second housing arranged opposite to each other. The second housing has a curved surface at an edge, and the sound outlet hole is located on the curved surface.

In a possible design, the front shell is connected to the second housing, and the rear shell is connected to the first housing.

In a possible design, the speaker module and the sound conduction tube are arranged at an edge of the housing, and the front shell and the sound-emitting unit are arranged obliquely relative to a surface of the rear shell.

In a possible design, the through hole is located on a side surface of the second front shell portion, so that the sound conduction tube extends from a side of the second front shell portion.

In a possible design, a shape of an outer surface of the second front shell portion corresponds to a shape of the curved surface of the second housing.

In a possible design, a ventilation block member is arranged in the sound outlet hole.

### BRIEF DESCRIPTION OF THE DRAWINGS

FIG. 1 is a partial cross-sectional view of an example of an electronic device according to an embodiment of this application;

FIG. 2 is a partial cross-sectional view of another example of an electronic device according to an embodiment of this application;

FIG. 3 is a schematic diagram of an example of a speaker module and a sound conduction tube according to an embodiment of this application;

FIG. 4 is a schematic diagram of another example of a speaker module and a sound conduction tube according to an embodiment of this application;

FIG. 5 is a schematic diagram of another example of a speaker module and a sound conduction tube according to an embodiment of this application;

FIG. 6 is an exploded view of the speaker module in FIG. 5;

FIG. 7 is a schematic diagram of another example of a sound conduction tube according to an embodiment of this application;

FIG. 8 is a schematic diagram of another example of a sound conduction tube according to an embodiment of this application;

FIG. 9 is a schematic diagram of another example of a sound conduction tube according to an embodiment of this application;

FIG. 10 is a schematic diagram of the speaker module and the sound conduction tube in FIG. 5 from another angle of view;

FIG. 11 is an exploded view of the speaker module in FIG. 10;

FIG. 12 is an enlarged view of a position A in FIG. 11;

FIG. 13 is an enlarged view of a position B in FIG. 11;

FIG. 14 is a cross-sectional view of an example of a speaker module and a sound conduction tube according to an embodiment of this application;

FIG. 15 is an enlarged view of a position C in FIG. 14;

FIG. 16 is a schematic diagram of an example of an electronic device according to an embodiment of this application;

FIG. 17 is a schematic diagram of disassembly of a second housing of an electronic device according to an embodiment of this application;

FIG. 18 is a cross-sectional view along a line E-E in FIG. 16;

FIG. 19 is an enlarged view of a position D in FIG. 18; and

FIG. 20 shows a frequency response curve of a speaker of the electronic device in FIG. 17.

### REFERENCE NUMERALS

10: housing; 11: sound outlet hole; 12: first housing; 121: keyboard; 13: second housing; 131: foot; 132: curved surface;
20: speaker module; 21: shell; 211: front sound cavity; 212: rear sound cavity; 213: through hole; 214: front shell; 214a: first front shell portion; 214b: second front shell portion; 214c: annular block; 214d: bump; 214e: step; 215: rear shell; 22: sound-emitting unit; 221: clamping slot;
30: sound conduction channel; 31: input end; 32: diffusion end;
40: sound conduction tube; 41: first tube section; 42: second tube section; 43: third tube section;
50: battery module; 60: desktop; and 61: gap.

### DETAILED DESCRIPTION OF ILLUSTRATIVE EMBODIMENTS

The following describes examples of possible related content in embodiments of this application. Apparently, the described embodiments are merely some embodiments rather than all embodiments of this application.

In descriptions of embodiments of this application, it should be noted that, unless otherwise explicitly specified or defined, terms such as “install”, “connect”, and “connection” should be understood in a broad sense. For example, the connection may be a fixed connection, a detachable connection, or an integral connection; a mechanical connection, an electrical connection, or mutual communication; or a direct connection, an indirect connection through an intermediate, or internal communication between two elements or an interaction relationship between two elements. A person of ordinary skill in the art may understand specific meanings of the foregoing terms in this application according to specific situations.

In the descriptions of this application, it should be understood that an orientation or a position relationship indicated by terms “above”, “below”, “side”, “inner”, “outer”, “top”, “bottom”, and the like is an orientation or a position relationship based on installation, and is merely intended for ease of describing this application and simplifying description, but does not indicate or imply that a described apparatus or element needs to have a specific orientation or be constructed and operated in a specific orientation. Therefore, such terms shall not be understood as a limitation on this application.

It should be further noted that a same reference numeral in embodiments of this application represents a same part or a same component. For a same component in embodiments of this application, only one part or component may be used as an example to mark a reference numeral in the figures. It should be understood that, for another same part or component, the reference numeral is also applicable.

In descriptions of embodiments of this application, it should be noted that, the term “and/or” used herein describes only an association relationship for describing associated objects and represents that three relationships may exist. For example, A and/or B may represent the following three cases: Only A exists, both A and B exist, and only B exists.

A speaker is a commonly used electro-acoustic transducer device. A main working principle of the speaker is that an electrified element drives a diaphragm to produce mechanical vibrations and propel surrounding air, causing an air medium to generate fluctuation, to implement “electro-force-sound” conversion.

Common speaker types include moving coil speakers, moving iron speakers, coil-iron hybrid speakers, electromagnetic speakers, inductive speakers, electrostatic speakers, planar speakers, and ribbon speakers, and the like. Various types of speakers are widely used in electronic devices that need to produce sound, such as mobile phones, notebook computers, tablet computers, and televisions.

Generally, sound frequencies audible to the human ear are in a range of 20 Hz to 20 KHz. 100 Hz to 3000 Hz is defined as a medium-low frequency band.

When a user uses electronic devices such as a mobile phone, a notebook computer, a tablet computer, and a television, sound quality of a speaker at a medium-low frequency directly determines performance of the speaker, and has a significant impact on sound quality experience of the user. This is because most sound frequencies of musical instruments and most human voice frequencies are in a medium-low frequency band, that is, the frequencies are centralized in the range of 100 Hz to 3000 Hz. If sensitivity of the speaker in this frequency band is higher, hearing experience of the user is better. Therefore, to improve the sound quality experience of the user using the speaker, related electronic device manufacturers focus on performance optimization of sound performance of the speaker in the medium-low frequency band.

In the related art, the speaker of the electronic device is directly in communication with the outside through a duct. In optimizing the sound performance of the speaker in the medium-low frequency band, the hearing experience for the medium-low frequency band is improved primarily by increasing a rear sound cavity, reducing an equivalent radiant area, increasing compliance of a corrugated rim, increasing mass of a voice coil, increasing an electromechanical coupling factor, and so on. However, these manners have a limited effect on sound quality improvement of the speaker in the medium-low frequency band, and cannot not satisfy constant pursuit of users for the sound quality experience of the speaker.

Therefore, to resolve a technical problem in the related art of a limited effect on sound quality improvement of speakers in the medium-low frequency band, a sound conduction channel of a horn-like spatial structure is designed, to improve sensitivity of the speaker in the medium-low frequency band, providing the user with better hearing experience.

The electronic device provided in this application is described in detail with reference to the accompanying drawings.

FIG. 1 is a partial cross-sectional view of an example of an electronic device according to an embodiment of this application.

As shown in FIG. 1, an embodiment of this application provides an electronic device, including a housing 10, a speaker module 20, and a sound conduction channel 30.

The housing 10 is provided with a sound outlet hole 11 communicating an inside of the housing 10 with the outside. The housing 10 is an outer protective shell of the electronic device, and has an accommodating space inside for mounting components such as the speaker module 20, a battery module 50, and a processor.

The speaker module 20 is arranged in the housing 10. The speaker module 20 includes a shell 21 and a sound-emitting unit 22 arranged in the shell 21. The sound-emitting unit 22 and the shell 21 enclose a front sound cavity 211, and a through hole 213 communicating the front sound cavity 211 with the inside of the housing 10 is provided on the shell 21. In addition, the speaker module 20 further has a rear sound cavity 212. The rear sound cavity 212 may be formed by a part of space separated by the sound-emitting unit 22 from inside the shell 21. Alternatively, the shell 21 does not participate in forming the rear sound cavity 212, and an entire space of the electronic device forms the rear sound cavity 212. The front sound cavity 211 and the rear sound cavity 212 are configured for separating front sound waves from rear sound waves, preventing the front sound waves and the rear sound waves from interfering with each other to cause an acoustic short circuit.

The sound conduction channel 30 includes an input end 31 for receiving sound waves and a diffusion end 32 for diffusing sound waves. The input end 31 of the sound conduction channel 30 communicates with the front sound cavity 211 through the through hole 213. The diffusion end 32 communicates with the outside through the sound outlet hole 11. A cross-sectional area of the sound conduction channel 30 increases gradually in a direction from the input end 31 to the diffusion end 32, so that the sound conduction channel 30 forms a horn-like spatial structure.

It is known that effects of forces are reciprocal, when the sound-emitting unit 22 vibrates in the air to radiate sound waves outwards, there is necessarily a reaction force from the air to the sound-emitting unit 22. For a sound-source vibration system, this is equivalent to adding force impedance to an original mechanical vibration system. Such force impedance added to the mechanical system due to sound radiation is referred to as radiation force impedance, and is simply referred to as radiation impedance. Due to the radiation impedance, an energy loss is caused during operation of the speaker. The energy loss is not lost to the air in a form of thermal energy, but is converted into acoustic energy and transmitted in a form of sound waves. Moreover, greater radiation impedance indicates that more energy is transmitted in the form of sound waves in the speaker. Therefore, efficiency of electro-acoustic conversion of the speaker is higher.

In this application, the cross-sectional area of the sound conduction channel 30 of the electronic device generally increases in the direction from the input end 31 to the diffusion end 32, so that the sound conduction channel 30 exists in the horn-like spatial structure. Compared with a conventional sound conduction duct structure, the horn-like sound conduction channel 30 can produce higher radiation impedance for the sound-emitting unit 22. Therefore, driven at a same power, the speaker of the electronic device in this application has higher efficiency when performing electric-acoustic conversion, leading to an increase in a sound pressure level of the sound-emitting unit 22 in each audio frequency band, particularly in the medium-low frequency band, in which sensitivity of the sound-emitting unit 22 is higher. Therefore, the speaker performs better in resolving most musical instrument sounds and human voices, thereby improving hearing enjoyment of the user.

In conclusion, in the electronic device provided in this embodiment of this application, the sound conduction channel of the horn-like spatial structure is designed, so that the speaker of the electronic device has the advantages of high efficiency of electric-acoustic conversion, high sensitivity in the medium-low frequency band, and good user hearing experience.

Optionally, the sound-emitting unit 22 includes a diaphragm and a driving apparatus arranged on a side of the diaphragm. The driving apparatus is configured to drive the diaphragm to vibrate, to propel the air to vibrate to form sound waves.

Optionally, the driving apparatus may be a moving coil driving apparatus, a capacitive driving apparatus, a reed driving apparatus, or a crystal driving apparatus.

Optionally, the driving apparatus may be connected to a main board circuit through a spring sheet, a board-to-board (Board to Board, BTB) connector, or the like.

Optionally, the electronic device may be a mobile or fixed terminal having a speaker, such as a mobile phone, a tablet computer, a notebook computer, a laptop computer, a television, an electronic watch, a walkie-talkie, a wearable device, or a virtual reality device.

Optionally, when the electronic device is a mobile phone, the speaker module 20 may be a loudspeaker, or may be an earpiece speaker.

Optionally, the speaker module 20 and the sound conduction channel 30 may also be incorporated into an in-vehicle speaker of a vehicle such as a car, a motorcycle, a subway, or the like.

Optionally, the sound conduction channel 30 may be enclosed by internal components of the electronic device and an inner wall of the housing 10 in cooperation.

Specifically, the sound conduction channel 30 may be enclosed by components, such as the battery module 50 and a display module, and the inner wall of the housing 10 in cooperation. The components such as the battery module 50 and the display module are particularly used because surfaces of such components are relatively flat and uniform, to enclose and form a regular sound conduction channel 30 with the inner surface of the housing 10. In addition, the components such as the battery module 50 and the display module further have a larger surface area than other modules, so that the sound conduction channel 30 of a larger length can be formed.

For example, as shown in FIG. 1, the sound outlet hole 11 is provided at a corner of the housing 10 so that the inner surface of the housing 10 can be better utilized, and then the battery module 50 is arranged obliquely, or is designed to have a surface of an inclined structure, so that the surface of the battery module 50 and the inner surface of the housing 10 can enclose a sound conduction channel 30 having a small cross-sectional area at one end and a large cross-sectional area at the other end in cooperation.

Optionally, the sound conduction channel 30 may alternatively be formed by a separately added sound conduction tube 40. For more detailed description, refer to the embodiments described below.

Optionally, the through hole 213 may be provided on a surface or a side surface of the shell 21 as long as the front sound cavity 211 can be communicated.

Optionally, the sound outlet hole 11 may be provided on a front surface, a rear surface, or a side surface of the housing 10.

Optionally, contour lines of cross-section of the sound conduction channel 30 include a conical (Conical) shape, an exponential (Exponential) shape, a hyperbolic (Hyperbolic), a tractrix (Tractrix) shape, and a combined (Combined) shape.

Optionally, in the electronic device of this application, based on use of the horn-like sound conduction channel 30, the hearing experience for the medium-low frequencies can be further improved by increasing the rear sound cavity, reducing an equivalent radiant area, increasing compliance of a corrugated rim, increasing mass of a voice coil, increasing an electromechanical coupling factor, and the like in the related art.

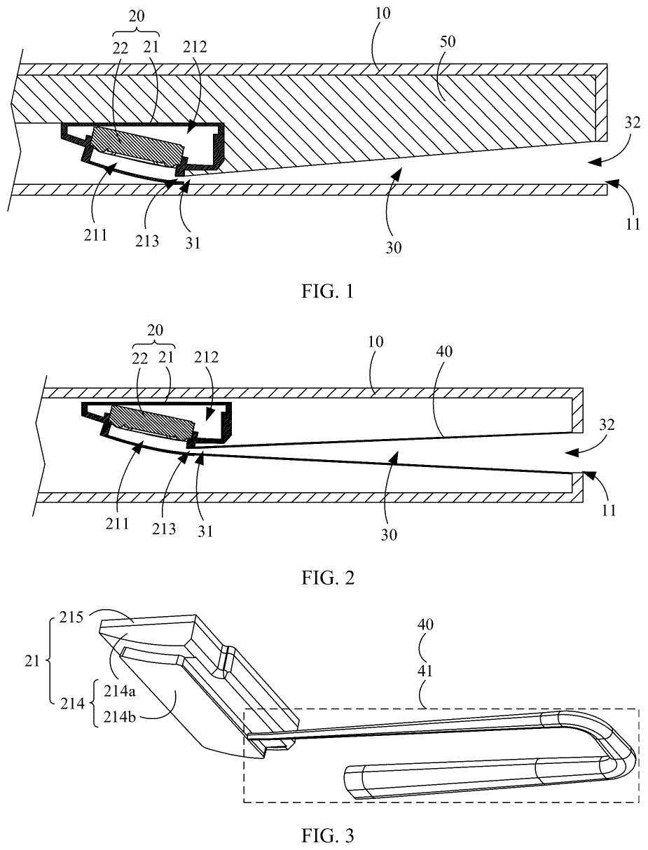

FIG. 2 is a partial cross-sectional view of another example of an electronic device according to an embodiment of this application.

As described above, the sound conduction channel 30 may alternatively be formed by a separately added sound conduction tube 40. In other words, in an embodiment provided in this application, as shown in FIG. 2, the electronic device further includes a sound conduction tube 40, and a tube cavity of the sound conduction tube 40 forms the sound conduction channel 30.

In this embodiment, the sound conduction channel 30 is formed by using the tube cavity of the sound conduction tube 40, so that a design position of the sound conduction channel 30 is more flexible, to facilitate deployment inside the electronic device. In addition, the design of the sound conduction tube 40 has advantages of a simple structure and easy molding.

In addition, in the foregoing manner of enclosing the sound conduction channel 30 using the battery module 50 and the display module, since sizes and structures of the battery module 50 and the display module are determined at a manufacturing stage, the sound conduction channel 30 cannot be optimized for a second time. In contrast, the sound conduction tube 40 in this embodiment is easily optimized for a second time. The sound conduction tube 40 may be directly cut, or a connection may be added to the sound conduction tube 40, so that the sound quality of different frequency bands can be correspondingly improved by changing a length and a cross-sectional area.

The sound conduction tube 40 in this embodiment of this application has different performance when the length changes. For example, the length of the sound conduction tube 40 may be increased by adding a connection, to further improve low frequency fade. In other words, a sound pressure level of the low frequency band below 100 Hz may be increased, thereby allowing the speaker to resolve sounds at lower frequency, allowing the user to hear more sounds at low frequency, implementing low frequency fade. The length of the sound conduction tube 40 may alternatively be shortened by half by cutting. In this case, the sound pressure level of the frequency band from 200 Hz to 3000 Hz may be increased, so that the sound conduction tube 40 can optimize sound quality in a specific frequency band, showing better pertinence.

Optionally, as shown in FIG. 2, an axis of the sound conduction tube 40 is always on a straight line in the direction from the input end 31 to the diffusion end 32. It may also be understood as that the sound conduction tube 40 is similar to an eccentric reducer in the chemical field in the related art. The sound conduction tube 40 of such a structure has a relatively simple structure and low processing costs.

Optionally, the axis of the sound conduction tube 40 is not on a same line in the direction from the input end 31 to the diffusion end 32. It may also be understood as that the sound conduction tube 40 is similar to an eccentric reducer in the chemical field in the related art. An appearance design of the sound conduction tube 40 of such a structure is more flexible, and the sound conduction tube 40 can be bent into various shapes, to be conveniently arranged inside the electronic device. For more detailed description, refer to the embodiments described below.

Optionally, end surfaces of tube openings at two ends of the sound conduction tube 40 are respectively bonded with the sound outlet hole 11 of the housing 10 and the through hole 213 of the shell 21; or two ends of the sound conduction tube 40 are respectively connected to the sound outlet hole 11 of the housing 10 and the through hole 213 of the shell 21 in a bell and spigot joint manner for fixing.

Specifically, the sound conduction tube 40 may be bonded with the housing 10 or the shell 21 in two implementations: One implementation is to attach an adhesive in advance to the end surface of the tube opening of the sound conduction tube 40, the sound outlet hole 11, and the through hole 213, center the sound conduction tube 40 with the sound outlet hole 11 and the through hole 213 respectively through a robot hand, and bond and fix the sound conduction tube 40 with the position of the sound outlet hole 11 and the position of the through hole 213. The other implementation is to insert the two ends of the sound conduction tube 40 into the sound outlet hole 11 and the through hole 213 after centering the sound conduction tube 40 with the sound outlet hole 11 and the through hole 213, respectively, then keep the robot hand stationary, and inject the adhesive into hole wall gaps 61 between the sound conduction tube 40 and the sound outlet hole 11 as well as the sound conduction tube 40 and the through hole 213 by using a glue dispensing tool.

Optionally, the sound conduction tube 40 may be connected to the shell 21 in an integral molding manner, and the other end of the sound conduction tube 40 is then connected to the sound outlet hole 11 of the housing 10 by adhesive or in the bell and spigot joint manner. Alternatively, the sound conduction tube 40 may alternatively be connected to the housing 10 in an integral molding manner, and the other end of the sound conduction tube 40 is then connected to the through hole 213 of the shell 21 by adhesive or in the bell and spigot joint manner.

In the above description of fixed mounting of the sound conduction tube 40, only fixing of the tube openings at the two ends of the sound conduction tube 40 is described, if the sound conduction tube 40 has a long tube cavity or a soft structure, the following problem may occur: When the sound-emitting unit 22 vibrates, the sound wave is radiated to the sound conduction tube 40. The sound wave is coupled to a tube body of the sound conduction tube 40, causing the sound conduction tube 40 to vibrate. If the sound conduction tube 40 is not fixed stably, the sound conduction tube 40 may shake in the electronic device. This affects the hearing experience of the sound quality at the medium-low frequency, causing distortion of medium-frequency sound, and if a shake amplitude is too large, the sound conduction tube 40 may hit the housing 10 to produce noise, affecting sound quality experience of the user.

Therefore, to resolve the above problems, in an embodiment provided in this application, the sound conduction tube 40 is connected to the housing 10 by adhesive bonding or by a tube clamp bracket.

The tube clamp bracket is an apparatus for fixing tubes. The tube clamp bracket is widely used for vibration reduction scenarios, such as tubes or equipment in electric, metallurgical, petroleum, and chemical industries, and bridges, buildings, and large equipment. Correspondingly, design and processing of structural miniaturization for the tube clamp bracket in the related art may also be applied to the fixing manner for the sound conduction tube 40 provided in this embodiment of this application.

FIG. 3 is a schematic diagram of an example of a speaker module 20 and a sound conduction tube 40 according to an embodiment of this application.

As described above, the axis of the sound conduction tube 40 may not be on the same line in the direction from the input end 31 to the diffusion end 32. In other words, in an embodiment provided in this application, as shown in FIG. 3, the sound conduction tube 40 includes a first tube section 41. An end of the first tube section 41 is connected at the sound outlet hole 11 of the housing 10, and an other end of the first tube section 41 is connected to the through hole 213 of the shell 21. The entire first tube section 41 is arranged in a meandering manner.

In this embodiment, the sound conduction tube 40 is designed as a meandering structure, ensuring that when the sound conduction tube 40 has a sufficient tube cavity length, the entire structure of the sound conduction tube 40 can be relatively compact, to be conveniently arranged inside the electronic device, and the internal space of the electronic device can be sufficiently and properly utilized.

Optionally, the first tube section 41 may be bent into an L-shaped structure, a U-shaped structure, an S-shaped structure, or a spiral structure. Details are described below.

As shown in FIG. 3, in an embodiment provided in this application, the first tube section 41 of the sound conduction tube 40 is bent in a U-shaped structure.

In this embodiment, the sound conduction tube 40 is designed to be bent in the U-shaped structure, ensuring that with sufficient tube cavity length of the sound conduction tube 40, an overall length of the sound conduction tube 40 can be only half of the tube cavity length. In addition, since the input end 31 having a small cross-sectional area is bent to the diffusion end 32 having a large cross-sectional area, an overall width of the sound conduction tube 40 is also relatively uniform and regular. This is conducive to arrangement in an electronic device.

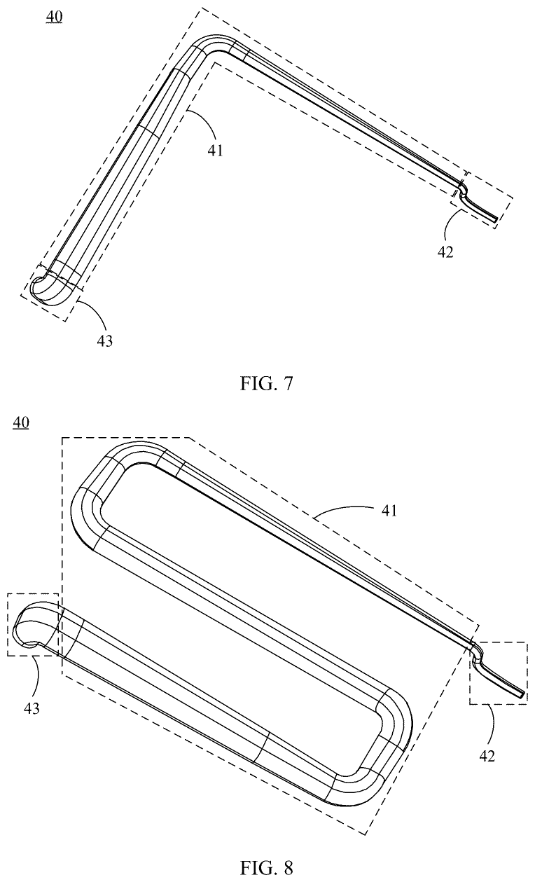

FIG. 7 is a schematic diagram of another example of a sound conduction tube 40 according to an embodiment of this application.

As shown in FIG. 7, in another embodiment provided in this application, the first tube section 41 of the sound conduction tube 40 may alternatively be bent in an L-shaped structure.

In this embodiment, the sound conduction tube 40 is designed to be bent in the L-shaped structure, and therefore, the sound conduction tube 40 may be arranged at a corner position of the electronic device. For example, when the electronic device is a mobile phone, the L-shaped sound conduction tube 40 may be arranged at any one of four corners of the mobile phone, so that internal space of the mobile phone can be sufficiently and properly utilized.

FIG. 8 is a schematic diagram of another example of a sound conduction tube 40 according to an embodiment of this application.

As shown in FIG. 8, in another embodiment provided in this application, the first tube section 41 of the sound conduction tube 40 may alternatively be bent in an S-shaped structure.

In this embodiment, the sound conduction tube 40 is bent in the S-shaped structure, so that the sound conduction tube 40 may be arranged in a gap 61 between components of the electronic device. For example, when the electronic device is a notebook computer, the S-shaped sound conduction tube 40 may be arranged in the gap 61 between the components such as a fan module, an optical drive module, and a hard disk module, so that internal space of the notebook computer can be sufficiently and properly utilized.

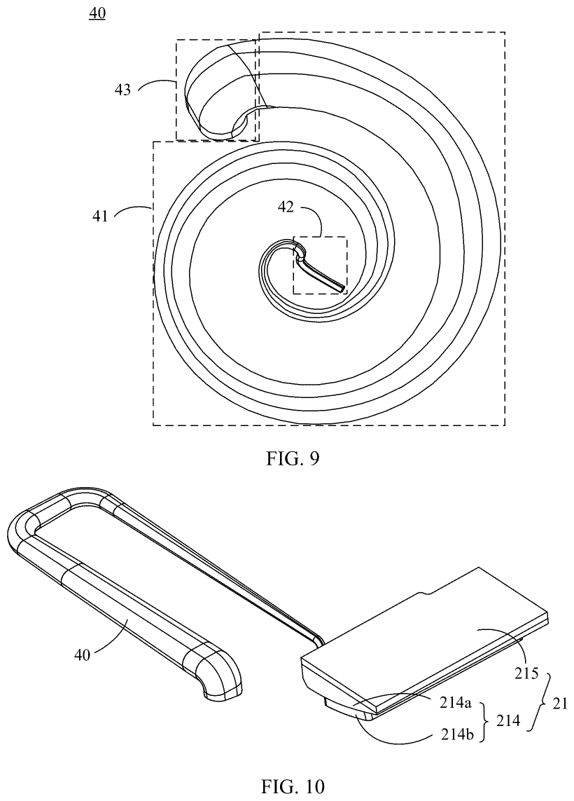

FIG. 9 is a schematic diagram of another example of a sound conduction tube 40 according to an embodiment of this application.

As shown in FIG. 9, in another embodiment provided in this application, the first tube section 41 of the sound conduction tube 40 may alternatively be bent in a spiral structure.

In this embodiment, the sound conduction tube 40 is designed to be bent in the spiral structure. A large arrangement space is occupied inside the electronic device. However, since the sound conduction channel 30 formed by the sound conduction tube 40 always transitions in a smooth arc from the input end 31 to the diffusion end 32, the sound waves can be smoothly diffused out of the sound outlet hole 11 through the sound conduction channel 30. The sound conduction channel 30 has less blocking effect on the sound waves, and energy loss when the sound waves propagate in the sound conduction channel 30 is less, so that the sound quality of the medium-low frequency is better improved.

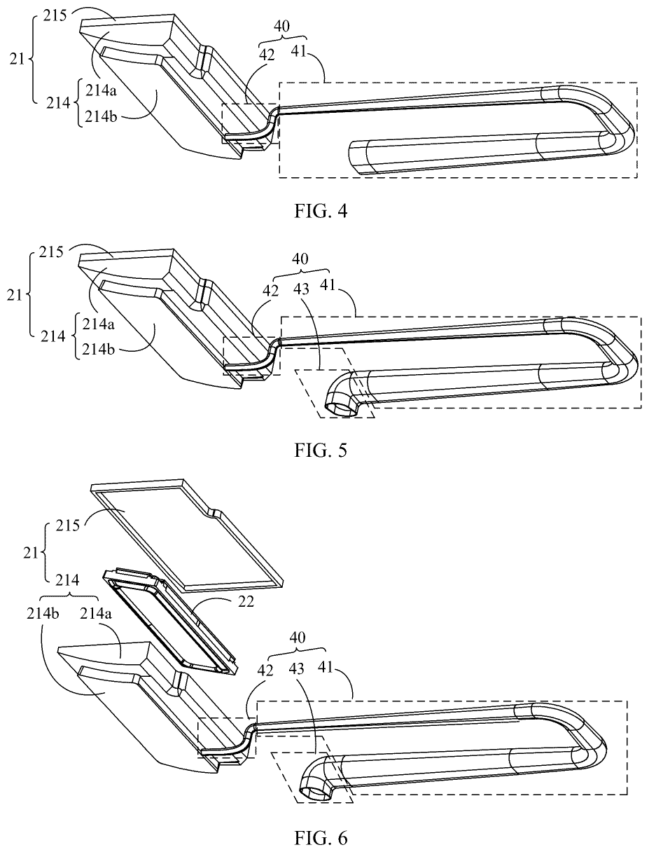

FIG. 4 is a schematic diagram of another example of a speaker module 20 and a sound conduction tube 40 according to an embodiment of this application.

As shown in FIG. 4, in an embodiment provided in this application, the sound conduction tube 40 further includes a second tube section 42. The first tube section 41 is connected at the through hole 213 through the second tube section 42, and the second tube section 42 is bent and arranged closely on an outer surface of the shell 21.

In this embodiment, a second tube section 42 is added between the first tube section 41 and the shell 21. The first tube section 41 can be guided towards the inner surface of the housing 10 after the second tube section 42 is bent. Specifically, in a case shown in FIG. 3, without the second tube section 42, the first tube section 41 is suspended inside the electronic device and occupies more space. In a case shown in FIG. 4, the second tube section 42 can guide the first tube section 41 towards the inner surface of the housing 10, thereby avoiding space directly below the first tube section 41. Other components can be arranged in the space, so that the structure inside the electronic device is better optimized.

In addition, as described above, the sound conduction tube 40 is connected to the housing 10 by adhesive bonding or by the tube clamp bracket. If the second tube section 42 is not provided, the tube clamp bracket needs to be added when the first tube section 41 is mounted and fixed, resulting in an excessive number of elements, a complicated structure, and an increased production cost of the electronic device. However, the second tube section 42 is bent, so that the first tube section 41 can be arranged against the inner surface of the housing 10, making it convenient to bond the first tube section 41 with the inner surface of the housing 10 by an adhesive.

In addition, in this embodiment, the sound conduction tube 40 may be fast and firmly fixed on the inner surface of the housing 10 by bonding. This is easy to implement.

In addition, the second tube section 42 is arranged closely on the outer surface of the shell 21, so that space around the shell 21 can be fully utilized. Since the second tube section 42 is closer to the input end 31, and has a small cross-sectional area and a small tube diameter, the second tube section 42 may even be arranged closely around the shell 21, to further increase the length of the tube cavity of the sound conduction tube 40, so that an overall structure of a speaker assembly formed by the two parts is compact.

Optionally, the first tube section 41 and the second tube section 42 may alternatively be connected by bonding or in a bell and spigot joint manner. Alternatively, the first tube section 41 and the second tube section 42 are integrally formed directly through an injection molding process, or integrally formed by using a 3D printing technology.

FIG. 5 is a schematic diagram of another example of a speaker module 20 and a sound conduction tube 40 according to an embodiment of this application.

As shown in FIG. 5, in an embodiment provided in this application, the sound conduction tube 40 further includes a third tube section 43. The first tube section 41 is connected at the sound outlet hole 11 through the third tube section 43, and the third tube section 43 is bent to compensate for a position offset of a tube opening of the first tube section 41 relative to the sound outlet hole 11.

As described in the foregoing embodiments, since the second tube section 42 is added between the first tube section 41 and the shell 21, the first tube section 41 can be guided by the second tube section 42 toward the inner surface of the housing 10 for arrangement, so that the first tube section 41 can be conveniently bonded on the inner surface of the housing 10. In a case that the first tube section 41 is arranged on the inner surface of the housing 10, an orientation of the tube opening of the first tube section 41 is limited. In other words, the tube opening of the first tube section 41 can only be aligned with and connected to the sound outlet hole 11 of the housing 10 that is directly open to the tube opening of the first tube section 41. For example, in a case shown in FIG. 4, the tube opening of the first tube section 41 faces horizontally toward the left side, and can only be aligned with and connected to the sound outlet hole 11 provided on a left side surface of the housing 10, so that an arrangement position of the sound outlet hole 11 of the electronic device is limited.

In addition to the above problem, the first tube section 41 further has a technical problem of being easily detached, and a specific reason is as follows: Theoretically, the tube opening of the first tube section 41 needs to be precisely aligned with and connected to the sound outlet hole 11 in a structural design stage. However, it is found in an actual production process that there is an inevitable dimensional tolerance for any component. A result of the dimensional tolerance existing on the tube opening of the first tube section 41 and the sound outlet hole 11 is that the tube opening of the first tube section 41 and the sound outlet hole 11 cannot be precisely aligned. During mounting, the tube opening of the first tube section 41 and the sound outlet hole 11 need to be forced to be connected in alignment depending on elastic deformation of the first tube section 41. In this case, a joint between the tube opening of the first tube section 41 and the sound outlet hole 11 is always stressed due to an elastic force of the first tube section 41. As described above, the sound-emitting unit 22 radiates the sound waves to the sound conduction tube 40 when vibrating, and the sound waves are coupled to the tube body of the sound conduction tube 40, to cause the sound conduction tube 40 to vibrate. Under the two situations, the tube opening of the first tube section 41 has a risk of falling out of the sound outlet hole 11.

Therefore, to resolve the two problems, in this embodiment, the third tube section 43 is added between the first tube section 41 and the housing 10. The third tube section 43 is bent to compensate for the position offset of the tube opening of the first tube section 41 relative to the sound outlet hole 11, thereby adapting to layouts of the sound outlet hole 11 at different positions, and compensating for an alignment tolerance of the tube opening of the first tube section 41 with the sound outlet hole 11, to prevent the tube opening of the first tube section 41 from falling out of the sound outlet hole 11.

Optionally, the first tube section 41 and the third tube section 43 may be manufactured together in advance, that is, integrally formed through the injection molding process, or integrally formed by using the 3D printing technology, and then directly connected to the sound outlet hole 11 of the housing 10 during assembly.

Optionally, during assembly, it is selected whether to add the third tube section 43 according to actual machining and mounting tolerances. If the third tube section 43 is added, the first tube section 41 and the third tube section 43 are connected by bonding or in a bell and spigot joint manner.

Specifically, the first tube section 41 may be a standard element, and the third tube section 43 may be tubes bent at different degrees of curvature, such as 30°, 45°, 60°, or 90°, according to an actual situation.

Optionally, when the first tube section 41 is bent in the L-shaped structure, the S-shaped structure, or the spiral structure, the second tube section 42 may alternatively be arranged on the first tube section 41 to guide the first tube section 41 toward the inner surface of the housing 10 for arrangement, and the third tube section 43 may be arranged to compensate for the position offset of the tube opening of the first tube section 41 relative to the sound outlet hole 11.

For example, in the sound conduction tube 40 shown in FIG. 7, the first tube section 41 is bent in the L-shaped structure, and two tube openings at two ends of the first tube section 41 are respectively connected to the second tube section 42 and the third tube section 43. In the sound conduction tube 40 shown in FIG. 8, the first tube section 41 is bent in the S-shaped structure, and the two tube openings at the two ends of the first tube section 41 are respectively connected to the second tube section 42 and the third tube section 43. In the sound conduction tube 40 shown in FIG. 9, the first tube section 41 is bent in the spiral structure, and the two tube openings at the two ends of the first tube section 41 are respectively connected to the second tube section 42 and the third tube section 43.

In an embodiment provided in this application, the cross-sectional shape of the sound conduction channel 30 includes one of a circle, a rectangle, or an ellipse.

When the cross-sectional shape of the sound conduction channel 30 is circular or elliptical, increase in frequency response of the medium-low frequency is apparent. Further, a circular sound conduction channel 30 has a much larger sound wave dispersion angle than an elliptical sound conduction channel 30. The elliptical sound conduction channel 30 has a peak in a region near a low-end cutoff frequency, while the circular sound conduction channel 30 still maintains a flat frequency response curve.

In conclusion, when the cross-sectional shape of the sound conduction channel 30 is circular, the electronic device in this embodiment of this application provides the best sound quality experience for the user when using the speaker.

In an embodiment provided in this application, bends of the first tube section 41, the second tube section 42, and the third tube section 43 are arc-shaped structures. The bend is the arc-shaped structure, allowing sound waves to be smoothly diffused outward.

In an embodiment provided in this application, the bends of the first tube section 41, the second tube section 42, and the third tube section 43 are right-angled structures, and a reflection plate is arranged in the tube cavity. To prevent the sound wave from being blocked when the bend is the right-angled structure, guiding diffusion for the sound wave is implemented by adding the reflection plate.

An important factor affecting sound quality experience for the speaker when the user uses the electronic device is a size of the rear sound cavity 212 of the speaker. A larger rear sound cavity 212 volume improves the low frequency characteristics of the sound, thereby results in better sound quality experience. The rear sound cavity 212 may be an open structure or a closed structure.

If the rear sound cavity 212 is of the open structure, the internal space of the entire electronic device needs to be used as the rear sound cavity 212, so that the volume of the rear sound cavity 212 may be large enough. However, if the rear sound cavity 212 is of the open structure, the sound-emitting unit 22 of the speaker radiates the sound waves into the inside of the electronic device when vibrating, and the sound waves are coupled with a battery cover or a rear cover of the electronic device, causing the battery cover or the rear cover to vibrate, affecting holding experience of the user. In addition, when holding the electronic device, the user unavoidably presses the battery cover or the rear cover, deformation of the battery cover or the rear cover caused by the pressing affects a volume of space of the entire equivalent rear sound cavity 212, and a sudden change in the volume of the space of the equivalent rear sound cavity 212 causes the speaker to produce noise, affecting the sound quality experience of the user.

Taking into account disadvantages of the open rear sound cavity 212, the electronic device in this embodiment of this application adopts a design of the closed rear sound cavity 212, and the volume of the rear sound cavity 212 is as large as possible.

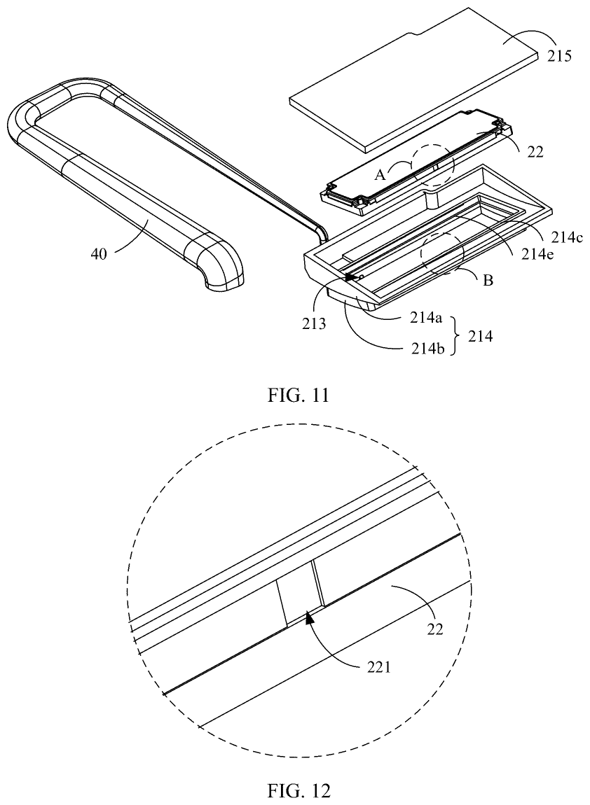

FIG. 6 is an exploded view of the speaker module 20 in FIG. 5. FIG. 10 is a schematic diagram of the speaker module 20 and the sound conduction tube 40 in FIG. 5 from another angle of view. FIG. 11 is an exploded view of the speaker module 20 in FIG. 10.

As shown in FIG. 6, FIG. 10, and FIG. 11, in an embodiment provided in this application, the shell 21 includes a front shell 214 and a rear shell 215. The front shell 214 includes a first front shell portion 214a and a second front shell portion 214b protruding from an outer surface of the first front shell portion 214a. The sound-emitting unit 22 is arranged at a joint between the first front shell portion 214a and the second front shell portion 214b, so that the sound-emitting unit 22 and the second front shell portion 214b enclose the front sound cavity 211, and the sound-emitting unit 22, the first front shell portion 214a, and the rear shell 215 enclose the rear sound cavity 212.

In this embodiment, the second front shell portion 214b protrudes from the outer surface of the first front shell portion 214a. The sound-emitting unit 22 is arranged at the junction between the first front shell portion 214a and the second front shell portion 214b. A contour of the second front shell portion 214b substantially corresponds to a contour of the sound-emitting unit 22, so that the sound-emitting unit 22 and the second front shell portion 214b enclose the front sound cavity 211. Since a size of the first front shell portion 214a is not limited by a size of the sound-emitting unit 22, the first front shell portion 214a may be designed to be more flat, and a lateral size may be as large as possible, to form a sufficiently large volume of the rear sound cavity 212 together with the rear shell 215. In this design, a thickness of the overall speaker module 20 is small while ensuring the sufficiently large volume of the rear sound cavity 212, satisfying development requirements of thinner and lighter electronic devices.

Optionally, the first front shell portion 214a and the second front shell portion 214b may be two pieces sealedly connected. Alternatively, the first front shell portion 214a and the second front shell portion 214b are integrally formed through the injection molding process, or are integrally formed by using the 3D printing technology.

Optionally, the rear shell 215 may be a straight plate shape, and directly cover at an opening of the second front shell portion 214b; or the rear shell 215 has a flange that is aligned with an edge of the second front shell portion 214b.

In an embodiment provided in this application, a root portion of the second front shell portion 214b extends in the direction of the rear shell 215 to form an annular block 214c, and the sound-emitting unit 22 is embedded inside the annular block 214c.

In this embodiment, the sound-emitting unit 22 is embedded inside the annular block 214c, so that the sound-emitting unit 22 is easily assembled to the shell 21.

Optionally, the sound-emitting unit 22 may be in an interference fit with the annular block 214c, and the sound-emitting unit 22 may be directly abutted against and fixed into the annular block 214c through an inner side of the annular block 214c. Alternatively, the sound-emitting unit 22 may have a rubber bump on an outer side. After the sound-emitting unit 22 is embedded inside the annular block 214c, the sound-emitting unit 22 is fixed inside the annular block 214c by a friction force generated by the rubber bump.

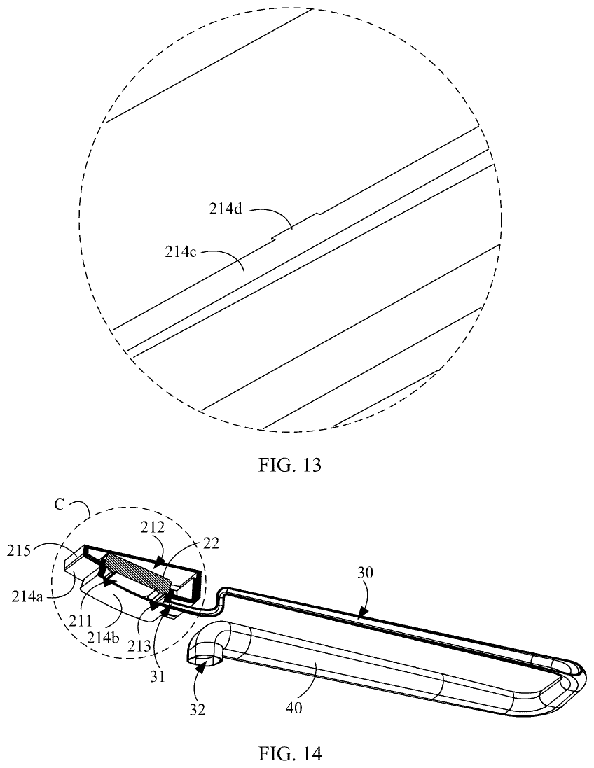

FIG. 12 is an enlarged view of a position A in FIG. 11. FIG. 13 is an enlarged view of a position B in FIG. 11.

In addition to the above manners in which the sound-emitting unit 22 is embedded and fixed inside the annular block 214c, in an embodiment provided in this application, another manner is described. Specifically, as shown in FIG. 12 and FIG. 13, a bump 214d is arranged on the inner side of the annular block 214c, and a clamping slot 221 is provided on the outer side of the sound-emitting unit 22. The bump 214d can be clamped in the clamping slot 221, so that the sound-emitting unit 22 is fixed and connected to the annular block 214c.

In another embodiment, substrates for arranging the bump 214d and the clamping slot 221 may be exchanged. That is, the clamping slot 221 is provided on the inner side of the annular block 214c, and the bump 214d is arranged on the outer side of the sound-emitting unit 22. The bump 214d can be clamped in the clamping slot 221, so that the sound-emitting unit 22 is fixed and connected to the annular block 214c.

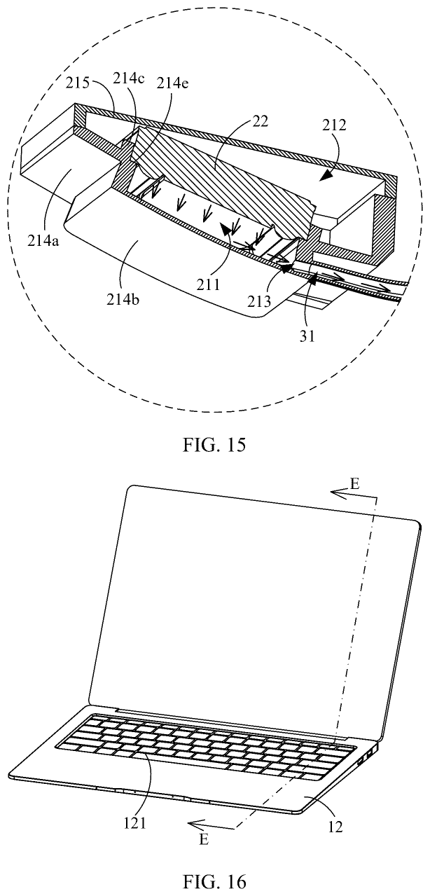

FIG. 14 is a cross-sectional view of an example of a speaker module 20 and a sound conduction tube 40 according to an embodiment of this application. FIG. 15 is an enlarged view of a position C in FIG. 14.

As shown in FIG. 11, FIG. 14, and FIG. 15, in an embodiment provided in this application, a step 214e around a circle is further arranged on the inner side of the annular block 214c, and the sound-emitting unit 22 abuts against the step 214e.

In this embodiment, the step 214e is mainly used as a positioning mechanism for positioning a mounting depth of the sound-emitting unit 22 in the annular block 214c, to prevent the sound-emitting unit 22 from being mounted excessively deep to compress the volume of the front sound cavity 211.

Optionally, a sealing member may further be arranged between the sound-emitting unit 22 and the step 214e, so that the sound-emitting unit 22 and the step 214e are sealedly connected.

Specifically, a foam or a rubber ring is pressed between a periphery of the sound-emitting unit 22 and the step 214e, to seal a gap between the sound-emitting unit 22 and the step 214e or a backing adhesive is bonded between the periphery of the sound-emitting unit 22 and the step 214e, to seal the gap between the sound-emitting unit 22 and the step 214e. Alternatively, at least one of glue, tape, adhesive, or the like having a buffering and sticking function may be used.

Due to existence of the step 214e, a larger contact area is provided for the sound-emitting unit 22 and the annular block 214c, ensuring a sealing effect for the sound-emitting unit 22 and the step 214e.

In the electronic device such as a notebook computer, a tablet computer, and a television, edges of the rear surface (or referred to as a rear housing, a rear cover, a battery cover, a housing D, or the like) of the housing 10 are generally curved surfaces. An objective is to provide a good visual effect. The electronic device looks thinner than an actual thickness when the user looks at the electronic device from a side surface, and looks light and thin, improving appearance aesthetics of the electronic device. Another objective is convenient picking. The curved surface causes a gap 61 between the rear surface of the housing 10 and a desktop 60. When the electronic device is placed on an object such as the desktop 60, the user can lift the electronic device by easily extending fingers into the gap 61 between the rear surface of the housing 10 and the desktop 60. If the rear surface of the housing 10 is of a flat structure, the user needs to pick the electronic device with fingers. This is inconvenient.

As described above, the sound outlet hole 11 may be provided on the front surface, the rear surface, or the side surface of the housing 10. When the sound outlet hole 11 is provided on the rear surface of the housing 10, to prevent the sound quality from being affected due to the sound waves flowing out of the sound outlet hole 11 being blocked by the desktop 60 or the like, the sound outlet hole 11 is preferably provided on the curved surface, as shown in the following embodiment.

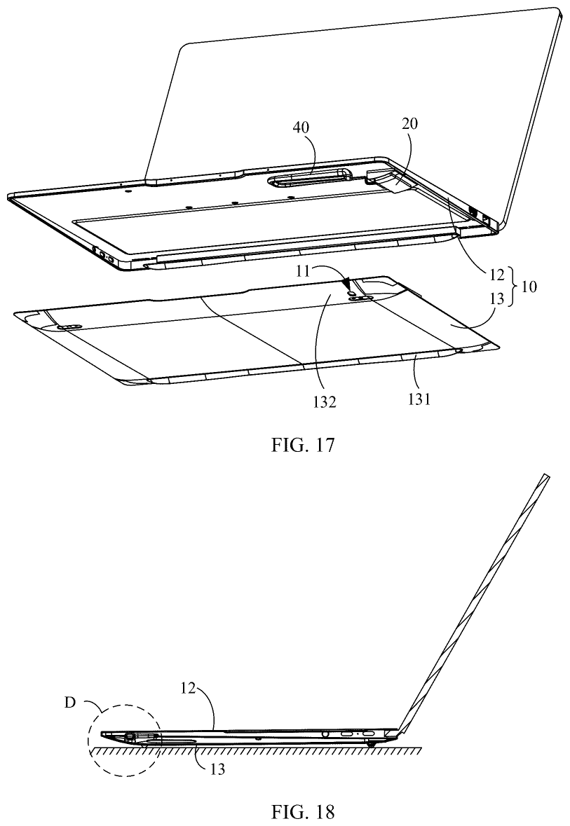

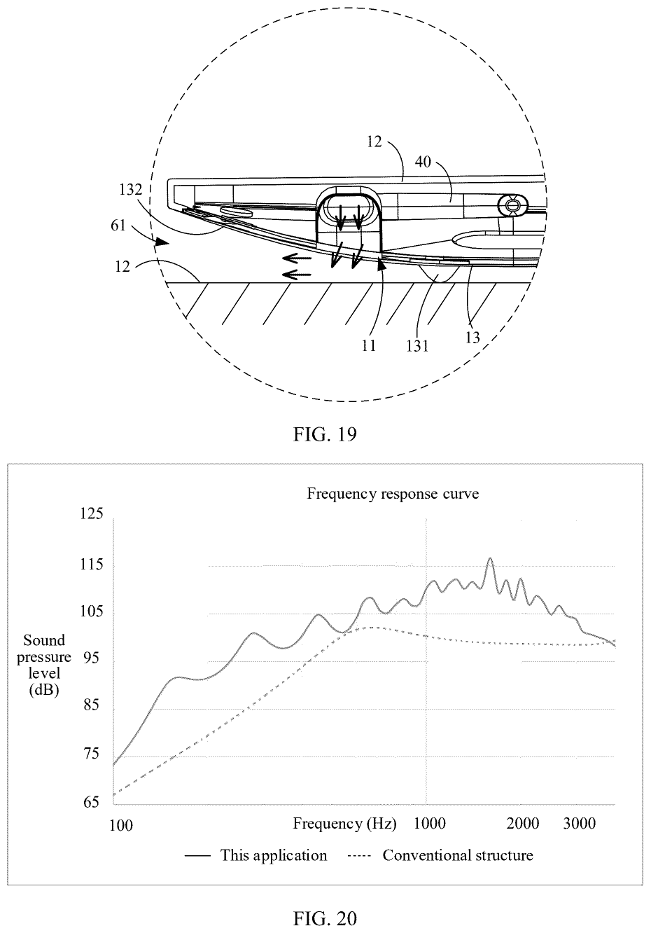

FIG. 16 is a schematic diagram of an example of an electronic device according to an embodiment of this application. FIG. 17 is a schematic diagram of disassembly of a second housing 13 of an electronic device according to an embodiment of this application. FIG. 18 is a cross-sectional view along a line E-E in FIG. 16. FIG. 19 is an enlarged view of a position D in FIG. 18.

As shown in FIG. 16 to FIG. 19, in an embodiment provided in this application, the housing 10 includes a first housing 12 and a second housing 13 arranged opposite to each other. The second housing 13 has a curved surface 132 at an edge, and the sound outlet hole 11 is located on the curved surface 132.

In this embodiment, the sound outlet hole 11 is located on the curved surface 132 at the edge of the second housing 13, and there are mainly two advantages of arranging the sound outlet hole 11 at this position: One advantage is to avoid providing an opening on the first housing 12. Because the first housing 12 is the front surface of the housing 10, avoiding providing an opening on the front surface of the housing 10 can improve the appearance aesthetics of the electronic device. The other advantage is that the sound outlet hole 11 is located on the curved surface 132 at the edge of the second housing 13 preventing the sound quality from being affected due to the sound waves flowing out of the sound outlet hole 11 being blocked by the desktop 60, a wall surface, and the like.

Optionally, the electronic device in this embodiment may be a notebook computer or the like that needs to be placed on the desktop 60 during use; or may be an electronic device such as a mobile phone, or a tablet computer that may be placed on the desktop 60 for use; or may be an electronic device such as a television, a large screen, or a whiteboard suspended against a wall surface.

For example, as shown in FIG. 16 to FIG. 19, when the electronic device is the notebook computer, the notebook computer has a housing A for arranging a logo (logo), a housing B for arranging a display screen, a housing C (namely, the first housing 12) for arranging a keyboard 121 and a touchpad, and the housing D (namely, the second housing 13) for arranging feet 131. The housing A and the housing B are connected as a body, and the housing C and the housing D are connected as another body. Then the two bodies are connected together by a structure such as a hinge to achieve relative rotation. At the edge of the housing D is the curved surface 132, and the sound outlet hole 11 is located on the curved surface 132.

Still to FIG. 19, the housing D has the curved surface 132 at the edge. Because there is the gap 61 between the edge of the housing D and the desktop 60 due to existence of the curved surface 132, when the user wants to lift the notebook computer, the user can easily extend the fingers into the gap 61. In addition, the sound outlet hole 11 is also provided on the curved surface 132 of the housing D, to prevent the sound outlet hole 11 from being blocked by the desktop 60, so that the sound waves can flow out of the gap 61 and propagate to the user.

Optionally, the curved surface 132 does not need to be formed on the housing D at an edge of a side near the hinge, and the curved surface 132 is arranged at all the edges of the other three edges. The sound outlet hole 11 may be provided on one or more of the curved surface 132 at the edges of the three sides. Correspondingly, a corresponding number of speaker modules 20 and sound conduction tubes 40 are provided to be connected to the sound outlet hole 11.

Specifically, as shown in FIG. 18, the sound outlet hole 11 is provided on the curved surface 132 at the edge of the side opposite to the hinge, namely, a position closer to the user. The position allows the user to better receive sound waves. In addition, as shown in FIG. 19, since the sound outlet hole 11 is provided on the curved surface 132, a plane on which a hole opening of the sound outlet hole 11 is located is inclined relative to the desktop 60, making it easier for the sound waves to propagate toward the user when refracted from the desktop 60, and making the sound waves more directional and received by the user.

For another example, when the electronic device is a tablet computer, the tablet computer has the first housing 12 for arranging the display screen, and the second housing 13 opposite to the first housing 12. The second housing 13 has a curved surface 132 at each edge of a periphery, and the sound outlet hole 11 is located on the curved surface 132.

Optionally, the sound outlet hole 11 may be provided on one or more of the curved surface 132 at the edges of the four sides. Correspondingly, a corresponding number of speaker modules 20 and sound conduction tubes 40 are provided to be connected to the sound outlet hole 11.

In this embodiment, the tube opening of the sound conduction tube 40 is connected to the sound outlet hole 11 on the curved surface 132. Since the sound outlet hole 11 is particularly positioned on the curved surface 132, the third tube section 43 needs to be added to the sound conduction tube 40 to compensate for the position offset of the tube opening of the first tube section 41 relative to the position of the sound outlet hole 11.

In an embodiment provided in this application, the front shell 214 is connected to the second housing 13, and the rear shell 215 is connected to the first housing 12.

In another embodiment provided in this application, the front shell 214 is connected to the first housing 12, and the rear shell 215 is connected to the second housing 13.

Optionally, the front shell 214 may be fixed and connected to the first housing 12 by adhesive bonding, snapping, bolting, or the like; or the front shell 214 and the first housing 12 are directly integrally formed.

Optionally, the rear shell 215 may be fixed and connected to the second housing 13 by adhesive bonding, snapping, bolting, or the like; or the rear shell 215 and the second housing 13 are directly integrally formed.

The front shell 214 and the first housing 12, and the rear shell 215 and the second housing 13 are both connected by integral forming, which can reduce a number of elements, thereby simplifying a process flow of the assembly of the electronic device, reducing assembly difficulty, and improving assembly efficiency.

To make the speaker module 20 and the sound conduction tube 40 closer to the sound outlet hole 11, as shown in FIG. 17, in an embodiment provided in this application, the speaker module 20 and the sound conduction tube 40 are arranged at the edge of the housing 10, and the front shell 214 and the sound-emitting unit 22 are arranged obliquely relative to a surface of the rear shell 215.

The speaker module 20 and the sound conduction tube 40 in this embodiment are arranged at the edge of the housing 10, causing the speaker module 20 and the sound conduction tube 40 to be located closer to the sound outlet hole 11 than being arranged in a middle region of the housing 10, thereby causing the overall structure of the speaker assembly formed by the two parts to be compact, and avoiding space in the middle region for other functional modules, to facilitate structural optimization of the inside of the electronic device.

In addition, since the thickness the edge of the housing 10 formed by the first housing 12 and the second housing 13 is small due to the curved surface 132 at the edge of the second housing 13, it is necessary that the front shell 214 and the sound-emitting unit 22 are arranged obliquely relative to the rear shell 215, to be arranged closer to the edge of the housing 10 to avoid more space for the middle region.

As described above, the through hole 213 may be provided on the surface or the side surface of the shell 21 as long as the front sound cavity 211 can be communicated. Based on the front sound cavity 211 formed by the second front shell portion 214b, the through hole 213 may be provided on a surface or a side surface of the second front shell portion 214b.

As shown in FIG. 14 and FIG. 15, to prevent the sound conduction tube 40 from occupying space directly below the second front shell portion 214b, in an embodiment provided in this application, the through hole 213 is provided on the side surface of the second front shell portion 214b, so that the sound conduction tube 40 extends from a side of the second front shell portion 214b.

In this embodiment, the through hole 213 is provided on an outer side of the second front shell portion 214b. As shown in FIG. 14, the sound conduction tube 40 extends along the right side of the second front shell portion 214b, and does not occupy the space directly below the second front shell portion 214b, thereby reducing a size requirement for the electronic device (or the housing 10) in a thickness direction, so that the speaker module 20 can satisfy development requirements of thinner and lighter electronic devices. In other words, the speaker module 20, when being mounted to the edge of the housing 10, may be closer to the edge, so that there is no problem of interference between the curved surface 132 and the sound conduction tube 40, allowing the position of the speaker module 20 to be more flexible.

Optionally, the speaker module 20 and the sound conduction tube 40 may be arranged at any position in the housing 10, for example, in the middle region or at the edge of the housing 10, as long as it is ensured that the front sound cavity 211 and the sound outlet hole 11 are communicated by the sound conduction tube 40.

As shown in FIG. 15, in an embodiment provided in this application, the outer surface of the second front shell portion 214b corresponds to a shape of the curved surface 132 of the second housing 13.

In this embodiment, the outer surface of the second front shell portion 214b corresponds to the shape of the curved surface 132 of the second housing 13, so that the second front shell portion 214b can be arranged closely against the curved surface 132 to utilize the space in the electronic device (or the housing 10).

In an embodiment provided in this application, a ventilation block member is arranged in the sound outlet hole 11.

In this embodiment, the ventilation block member is mainly configured to prevent debris in an environment from entering the sound conduction hole and falling into the sound conduction tube 40, thereby effectively protecting the sound conduction tube 40 and the speaker module 20.

Optionally, the ventilation block member may be a scrim, a grating, or the like.

FIG. 20 shows a frequency response curve of a speaker of the electronic device in FIG. 17.

As shown in FIG. 17, in an embodiment provided in this application, the cross-sectional shape of the sound conduction tube 40 is elliptical, and the sound conduction tube 40 includes the first tube section 41 of the U-shaped structure, and the second tube section 42 and a third tube section 43 that are connected at the two ends of the first tube section 41. The third tube section 43 is in communication with the sound outlet hole 11 located on the curved surface 132 of the second housing 13.

As shown in FIG. 20, it can be seen from the frequency response curve of the speaker of the electronic device in this embodiment that the speaker having the sound conduction tube 40 in this embodiment of this application has a sound pressure level greater than that of the speaker having a conventional sound outlet channel structure, exhibits higher sensitivity in the medium-low frequency band from 100 Hz to 3000 Hz, and has better performance in resolving most musical instrument sound and human voices, thereby improving the hearing experience of the user in the medium-low frequency band.

Finally, it should be noted that: The foregoing descriptions are merely specific embodiments of this application, but are not intended to limit the protection scope of this application. Any variation or replacement within the technical scope disclosed in this application shall fall within the protection scope of this application. Therefore, the protection scope of this application shall be subject to the protection scope of the claims.

1. An electronic device, comprising:
a housing, provided with a sound outlet hole communicating an inside of the housing with the outside;
a speaker module, arranged in the housing, wherein the speaker module comprises a shell and a sound-emitting unit arranged in the shell, the sound-emitting unit and the shell enclose a front sound cavity, and a through hole communicating the front sound cavity with the inside of the housing is provided on the shell; and
a sound conduction channel, comprising an input end for receiving sound waves and a diffusion end for diffusing sound waves, wherein the input end of the sound conduction channel communicates with the front sound cavity through the through hole, the diffusion end communicates with the outside through the sound outlet hole, and a cross-sectional area of the sound conduction channel increases gradually in a direction from the input end to the diffusion end.

2. The electronic device according to claim 1, further comprising:
a sound conduction tube, wherein a tube cavity of the sound conduction tube forms the sound conduction channel.

3. The electronic device according to claim 2, wherein the sound conduction tube comprises a first tube section, an end of the first tube section is connected to the sound outlet hole of the housing, an other end of the first tube section is connected at the through hole of the shell, and the entire first tube section is arranged in a meandering manner.

4. The electronic device according to claim 3, wherein the first tube section is bent into an L-shaped structure, a U-shaped structure, an S-shaped structure, or a spiral structure.

5. The electronic device according to claim 3, wherein the sound conduction tube further comprises a second tube section, the first tube section is connected at the through hole through the second tube section, and the second tube section is bent and arranged closely on an outer surface of the shell.

6. The electronic device according to claim 5, wherein the sound conduction tube further comprises a third tube section, the first tube section is connected at the sound outlet hole through the third tube section, and the third tube section is bent to compensate for a position offset of a tube opening of the first tube section relative to the sound outlet hole.

7. The electronic device according to claim 2, wherein the sound conduction tube is connected to the housing by adhesive bonding or by a tube clamp bracket.

8. The electronic device according to claim 1, wherein a cross-sectional shape of the sound conduction channel comprises one of a circle, a rectangle, or an ellipse.

9. The electronic device according to claim 2, wherein the shell comprises a front shell and a rear shell, the front shell comprises a first front shell portion and a second front shell portion protruding from an outer surface of the first front shell portion, and the sound-emitting unit is arranged at a joint between the first front shell portion and the second front shell portion, so that the sound-emitting unit and the second front shell portion enclose the front sound cavity, and the sound-emitting unit, the first front shell portion, and the rear shell enclose a rear sound cavity.

10. The electronic device according to claim 9, wherein a root portion of the second front shell portion extends toward the rear shell to form an annular block, and the sound-emitting unit is embedded inside the annular block.

11. The electronic device according to claim 10, wherein a bump is arranged on one of an inner side of the annular block and the sound-emitting unit, a clamping slot is provided on the other of the inner side of the annular block and the sound-emitting unit, and the bump is configured to be clamped into the clamping slot, so that the sound-emitting unit is connected to the annular block.

12. The electronic device according to claim 11, wherein a step around a circle is further arranged on the inner side of the annular block, and the sound-emitting unit abuts against the step.

13. The electronic device according to claim 9, wherein the housing comprises a first housing and a second housing arranged opposite to each other, wherein the second housing has a curved surface at an edge, and the sound outlet hole is located on the curved surface.

14. The electronic device according to claim 13, wherein the front shell is connected to the second housing, and the rear shell is connected to the first housing.

15. The electronic device according to claim 14, wherein the speaker module and the sound conduction tube are arranged at an edge of the housing, and the front shell and the sound-emitting unit are arranged obliquely relative to a surface of the rear shell.

16. The electronic device according to claim 15, wherein the through hole is located on a side surface of the second front shell portion, so that the sound conduction tube extends from a side of the second front shell portion.

17. The electronic device according to claim 15, wherein a shape of an outer surface of the second front shell portion corresponds to a shape of the curved surface of the second housing.

18. The electronic device according to claim 1, wherein a ventilation block member is arranged in the sound outlet hole.
